(19) United States
(12) Patent Application Publication
(10) Pub. No.: US 2025/0350577 A1
(43) Pub. Date: Nov. 13, 2025

(54) HYBRID SMS, EMAIL, PHONE SEAMLESS HANDOVER COMMUNICATION SYSTEM

(71) Applicant: Entrata, Inc., Lehi, UT (US)

(72) Inventors: Ethan BAHIR, Petach Tikva (IL); Nir OSIROFF, Raanana (IL)

(21) Appl. No.: 19/201,824

(22) Filed: May 7, 2025

Related U.S. Application Data
(60) Provisional application No. 63/643,964, filed on May 8, 2024.

(51) Int. Cl. H04L 51/56; H04L 9/40; H04L 51/226

(52) U.S. Cl. CPC H04L 51/56; H04L 51/226; H04L 63/0428

(57) ABSTRACT

Systems and methods are provided for improving communication with residents. In the realm of rent collection automation, communication with residents plays a pivotal role. Aspects of this disclosure introduce a Hybrid Short Message Service (SMS), Email, and Phone Seamless Handover Communication System and methods of using such a system to optimize resident communication by seamlessly transitioning between different channels of communication with the resident. Aspects of the disclosure may improve communication effectiveness by delivering messages through the most preferred channel for a channel based on individual preferences and responsiveness. Aspects of the disclosure may foster deeper resident engagement by offering flexible and convenient communication options tailored to individual needs. Aspects of the disclosure may increase operational efficiency for property managers by streamlining communication workflows and automating channel handovers.

### CROSS REFERENCE

The present application for patent claims the benefit of U.S. Provisional Patent Application No. 63/643,964 by BAHIR et al., entitled “HYBRID SMS, EMAIL, PHONE SEAMLESS HANDOVER COMMUNICATION SYSTEM”, filed May 8, 2024, which is assigned to the assignee hereof, and is expressly incorporated by reference herein.

### FIELD OF THE DISCLOSURE

The disclosure relates to the field of real estate rental management and focuses on resident communication. More specifically, the disclosure relates to a system that facilitates seamless and context-aware handovers between different communication channels (SMS, email, phone) to optimize resident engagement and improve communication effectiveness.

### Introduction

In today's dynamic landscape of resident communication, single-channel approaches often prove inadequate. Residents exhibit diverse communication preferences, and circumstances can necessitate switching between SMS, email, and phone communication. This demands a system that effortlessly transitions between these channels while preserving context and maintaining a unified communication thread. The absence of such a system leads to several critical inefficiencies and limitations: Frustration and confusion; ineffective communication, limited reach; and/or reduced resident engagement. Frustration and confusion: Frustration may occur if residents are forced across different channels or struggle to navigate between channels, which may negatively impact engagement and satisfaction. Ineffective communication: Important information or nuances can be lost during handovers, hindering effective communication and resolution of issues. Limited reach: Relying on a single channel might exclude residents who prefer different communication methods, potentially missing crucial engagement opportunities. Reduced resident engagement: Inconvenient or restrictive communication methods can lead to decreased resident responsiveness and participation

### SUMMARY

In the realm of rent collection automation, communication with residents plays a pivotal role. Some methods may rely on single-channel communication, leading to inefficiencies and reduced engagement. Aspects of this disclosure introduce a Hybrid Short Message Service (SMS), Email, and Phone Seamless Handover Communication System to optimize resident communication by seamlessly transitioning between different channels. Aspects of the disclosure may improve communication effectiveness by delivering messages through the most suitable channel based on individual preferences and responsiveness. Aspects of the disclosure may reduce resident frustration by facilitating smooth and intuitive channel switching while maintaining continuity. Aspects of the disclosure may foster deeper resident engagement by offering flexible and convenient communication options tailored to individual needs. Aspects of the disclosure may increase operational efficiency for property managers by streamlining communication workflows and automating channel handovers.

A system for facilitating seamless communication handoff between Short Message Service (SMS), email, and phone channels is described. The system includes: a unified communication interface configured to: receive communication requests from a resident; identify a preferred communication channel based on resident preferences and communication history; route the communication requests to a designated communication channel based on the preferred communication channel; and store communication history across all channels for the resident; a resident communication preference module configured to store and manage resident preferences for receiving communication from a property manager; and at least one communication channel module configured to: send communication to the resident through the designated communication channel (SMS, email, or phone); and receive communication responses from the resident through the designated communication channel.

In some examples of the system described herein, the resident communication preference module is further configured to learn and update resident preferences based on resident interaction patterns across communication channels.

In some examples of the system described herein, the unified communication interface prioritizes routing communication requests based on urgency and a nature of the communication requests.

In some examples of the system described herein, the system prioritizes routing urgent communication requests, such as maintenance emergencies, through phone calls.

In some examples of the system described herein, the at least one communication channel module further comprises an SMS communication module configured to send and receive text messages with residents.

In some examples of the system described herein, the at least one communication channel module further comprises an email communication module configured to send and receive emails with residents.

In some examples of the system described herein, the at least one communication channel module further comprises a phone communication module configured to connect residents with property management representatives via phone calls.

In some examples of the system described herein, the system further includes a resident communication history module configured to store and manage all communication interactions between a resident and property management across all communication channels (SMS, email, and phone).

In some examples of the system described herein, the system further includes a contextual handover logic engine configured to analyze the communication history and resident preferences to determine a most effective communication channel for future outreach.

In some examples of the system described herein, the system further includes a real-time channel adaptability module configured to dynamically adjust the designated communication channel based on real-time resident behavior and preferences.

In some examples of the system described herein, the system further includes a feedback and analytics engine configured to: collect resident feedback regarding communication preferences; and analyze the resident feedback to refine communication strategies and optimize resident engagement.

In some examples of the system described herein, the system further includes an automated response generator configured to generate predefined responses to common resident inquiries.

In some examples of the system described herein, the unified communication interface and the at least one communication channel module comply with relevant data security protocols and utilize encryption techniques to safeguard resident communication data.

A method for facilitating seamless communication handoff between Short Message Service (SMS), email, and phone channels for resident communication within a real estate rental domain is described. The method may include: receiving a communication request from a resident; identifying a preferred communication channel for the resident based on resident preferences and communication history; routing the communication request to a designated communication channel (SMS, email, or phone) based on the preferred communication channel; storing the communication request and any responses within a resident communication history; and learning and updating resident communication preferences based on resident interaction patterns across communication channels.

A non-transitory computer-readable medium storing instructions executable by one or more processors is described. The instructions may be executable to by the one or more processors to: receive a communication request from a resident; identify a preferred communication channel for the resident based on resident preferences and communication history; route the communication request to a designated communication channel (SMS, email, or phone) based on the preferred communication channel; storing the communication request and any responses within a resident communication history; and learn and update resident communication preferences based on resident interaction patterns across communication channels.

In some examples of the method and non-transitory computer readable medium described herein, identifying a preferred communication channel prioritizes routing communication requests based on urgency and a nature of the communication request.

Some examples of the method and non-transitory computer readable medium described herein may further include operations or instructions for prioritizing routing urgent communication requests through phone calls.

Some examples of the method and non-transitory computer readable medium described herein may further include operations or instructions for analyzing the communication history and resident preferences to determine a most effective communication channel for future outreach.

Some examples of the method and non-transitory computer readable medium described herein may further include operations or instructions for dynamically adjusting the designated communication channel based on real-time resident behavior and preferences.

Some examples of the method and non-transitory computer readable medium described herein may further include operations or instructions for collecting resident feedback regarding communication preferences, and analyzing the resident feedback to refine communication strategies and optimize resident engagement.

Some examples of the method and non-transitory computer readable medium described herein may further include operations or instructions for comprising generating predefined responses to common resident inquiries.

Some examples of the method and non-transitory computer readable medium described herein may further include operations or instructions for complying with relevant data security protocols and utilizing encryption techniques to safeguard resident communication data.

The following is a simplified summary providing an initial understanding of the invention. The summary does not necessarily identify key elements nor limit the scope of the invention, but merely serves as an introduction to the following description.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout. In the accompanying drawings:

FIG. 1 illustrates a diagram of a system architecture of a hybrid communication system.

FIG. 2 is a flow chart that illustrates a method of communicating with a resident using a hybrid communication system.

FIG. 3 is a high-level block diagram of exemplary controllers, which may be used with embodiments of the present disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the evolving landscape of resident communication, a single-channel approach may be restrictive. Residents may have diverse preferences, and circumstances may demand or necessitate a switch between SMS, email, and phone communication. Thus, a system that effortlessly transitions between these channels while maintaining context may be demanded.

Aspects of this disclosure involve the integration of a hybrid communication system into Colleen.ai's platform or Property Management System (PMS). This system ensures a smooth handover between SMS, email, and phone communication channels, providing flexibility and enhancing resident engagement. Aspects of this disclosure may also diversify the communication channel after the handover

The present disclosure pertains to a Hybrid SMS, Email, and Phone Seamless Handover Communication System within the field of real estate rental management. This system addresses inefficiencies inherent in single-channel communication methods commonly used for resident outreach. The disclosure provides a unified communication interface within Colleen.ai, seamlessly integrating SMS, email, and phone functionalities. This interface may foster continuity by maintaining a complete conversation history regardless of the channel employed. Additionally, the system may incorporate intelligent handover logic. This logic may analyze resident communication preferences and historical interactions to determine the most effective channel for future outreach, ensuring contextually relevant messages are delivered through the most suitable avenue for each resident. By offering a flexible and resident-centric communication approach, the present disclosure aims to significantly improve resident engagement with property management. Furthermore, the system may optimize communication effectiveness and may reduce resident frustration by facilitating seamless handovers and maintaining conversational context. These advantages may ultimately contribute to increased operational efficiency for property managers by streamlining communication workflows and automating channel transitions.

The solution/system introduces a unified communication interface within Colleen.ai or property management system that seamlessly integrates SMS, email, and phone communication. This interface may be designed to maintain conversation history, ensuring continuity regardless of the communication channel used. The system may incorporate intelligent logic to determine the optimal channel for communication-based on resident preferences and responsiveness. This contextual handover may ensure that messages are delivered through the most effective channel for each resident, maximizing engagement.

The system may provide enhanced resident engagement. A primary advantage of the Hybrid SMS, email, and phone Seamless Handover Communication System is the ability to engage residents through their preferred channels. This adaptability increases the communication likelihood of timely responses and collaboration, ultimately improving rent collection outcomes. Thus, the system may also provide increased communication reach. For example, by seamlessly transitioning between SMS, email, and phone communication, the system expands the reach of communication efforts. Residents who may be more responsive to one channel over another can be effectively engaged, maximizing the overall communication reach. The system may also provide improved responsiveness. For example, the system's contextual handover logic may ensure that messages reach residents through the most responsive channel. This targeted approach may reduce response times, streamline communication, and contribute to a more efficient rent collection process.

The system may provide integration with the Colleen.ai platform or property management system. The Hybrid SMS, Email, and Phone Seamless Handover Communication System may integrate seamlessly with Colleen.ai's or property management system's existing platform. The Hybrid SMS, Email, and Phone Seamless Handover Communication System may leverage resident profiles, communication history, and preferences to determine the most effective channel for each interaction. The system may provide real-time adaptability. The system may operate in real-time, adapting to resident behavior and preferences on the fly. This real-time adaptability may ensure that communication remains effective and resident-focused throughout the rent collection process.

The Hybrid SMS, Email, and Phone Seamless Handover Communication System constitutes a meticulously designed suite of integrated components crafted to revolutionize resident communication within the real estate rental management domain. This innovative architecture fosters a cohesive and efficient communication experience by seamlessly transitioning between SMS, email, and phone channels. By catering to diverse resident preferences and maximizing engagement, the system empowers property managers to cultivate stronger relationships with their residents and streamline communication workflows.

At the heart of the system lies a centralized Unified Communication Interface. This interface may be imagined or considered as a virtual command center, acting as a unified platform for all communication channels (SMS, email, phone). This central hub may ensure a consistent and streamlined experience for both property managers and residents. All interactions, regardless of the channel used, may be meticulously captured and stored within this interface. This comprehensive communication history may empower property managers to maintain a holistic view of each resident's communication journey. For instance, a property manager may easily access a resident's past email inquiries about maintenance requests, the resident's SMS responses to rent payment reminders, and any phone conversations regarding lease renewals. This rich tapestry of communication history may enable property managers to tailor future interactions and personalize outreach strategies. Imagine a scenario where a resident consistently demonstrates a preference for email communication. By leveraging the communication history and resident preference settings, the system can automatically prioritize email for all future lease renewal notifications or general announcements directed towards that particular resident.

To ensure contextually relevant and effective communication, the system may leverage a sophisticated Contextual Handover Logic engine. This intelligent component may delve into the dedicated Communication History Database, meticulously analyzing resident communication preferences and past interactions. By gleaning valuable insights from this data, the Contextual Handover Logic engine strategically may determine the most effective channel for future outreach. For instance, if a resident consistently demonstrates a prompt response rate to text messages, the system may prioritize SMS for subsequent communication regarding urgent maintenance issues requiring a timely response. This resident-centric approach may guarantee that each resident receives messages through the resident's preferred and most responsive channel. For example, in a situation where a water leak occurs in a resident's apartment, the system, upon receiving a maintenance request, may analyze the resident's communication history and identify the resident's preference for text messages. Leveraging this information, the system may automatically send an SMS notification to the resident, ensuring the resident receives critical information about the issue through the resident's preferred channel and may respond promptly.

Furthermore, the system may incorporate a Real-time Channel Adaptability module that may dynamically adjust communication channels based on resident behavior and preferences. This adaptability may be fueled by a combination of historical data gleaned from the Communication History Database and real-time interactions with residents. For instance, if a resident consistently ignores email notifications but promptly responds to text messages regarding late rent payments, the system can dynamically adjust the system's communication strategy for that particular resident. In subsequent instances of late rent payments, the system may prioritize SMS notifications, increasing the likelihood of a timely response and resolution. This continuous learning and adaptation may ensure messages are delivered through the most responsive and preferred channel at any given time. Seamless integration with diverse communication platforms is facilitated by Channel-specific APIs. These APIs act as bridges, enabling the system to interact directly with SMS gateways, email servers, and phone systems. For example, an API may be considered as a specialized translator, allowing the system to seamlessly communicate with different communication platforms. This integration may guarantee efficient and reliable communication across all channels, fostering a seamless communication experience for both property managers and residents.

Resident communication preferences may be paramount to the system's effectiveness. The Resident Preference Management system may empower property managers to capture and manage these preferences with case. This feature may allow for the creation of tailored communication strategies that cater to individual needs. For example, a resident who consistently expresses a preference for email communication can be opted out of SMS notifications, ensuring the resident receives information through the resident's preferred channel. Additionally, a resident who prefers phone calls for lease renewal discussions can have the resident's communication settings adjusted accordingly.

The system's commitment to continuous improvement and resident satisfaction may be further exemplified by the robust Feedback and Analytics Engine. This engine may actively collect and analyze resident feedback regarding communication preferences. These valuable insights may empower property managers to continually refine communication strategies and optimize resident engagement. For example, in a scenario where a significant number of residents express frustration with receiving late rent payment reminders via phone calls, by analyzing this feedback through the Analytics Engine, property managers may identify this trend and adjust the communication strategy to prioritize email or text message notifications for future late rent reminders. Additionally, an Automated Response Generator may streamline communication by generating predefined responses to common resident inquiries. This feature may enhance efficiency by providing residents with prompt and accurate information, ultimately reducing the burden on property managers. For example, in a scenario where a resident submits a routine maintenance request regarding a burnt-out lightbulb, the system, upon receiving the request, can automatically generate a response outlining the estimated timeframe for a maintenance technician to address the issue.

Security handling and compliance may be of the utmost importance when residents communicate data. The Security and Compliance Layer may safeguard resident communication data by utilizing state-of-the-art encryption and access controls.

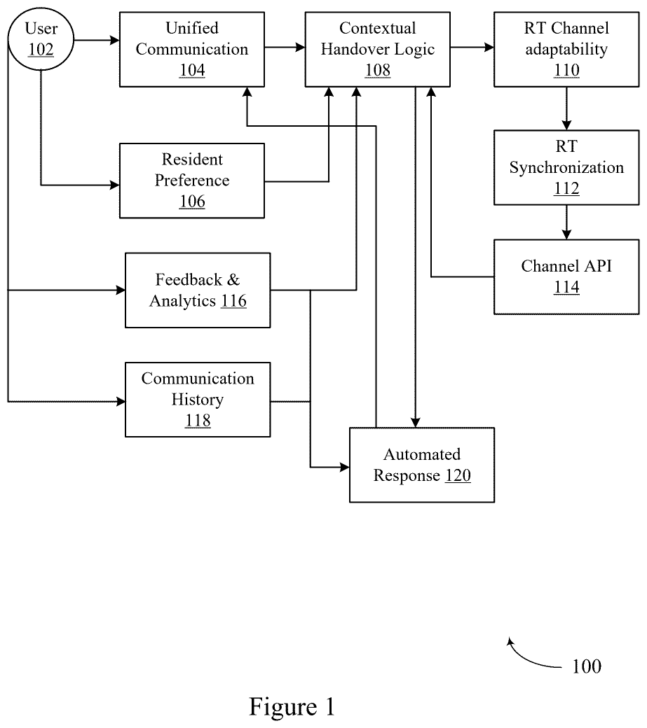

FIG. 1 illustrates a diagram of the system architecture 100 of the system as described herein. The system architecture 100 may be described with reference to FIG. 1. The Hybrid SMS, Email, and Phone Seamless Handover Communication System may be engineered to optimize resident communication by seamlessly transitioning between SMS, email, and phone channels. The system architecture 100 may include several components, each serving a role in ensuring a cohesive and efficient communication experience. The system architecture 100 may include a unified communication interface 104, a contextual handover logic component 108, a communication history database 118, a real-time adaptability module 110, channel specific APIs 114, a resident preference management system 106, a feedback and analytics engine 116, an automated response generator 120, a security and compliance layer, and a real-time synchronization module 112. The components of FIG. 1 may be implemented by storage device(s) 62 and processor(s) 63 coupled to storage device(s) 62 (see FIG. 4), which store software instructions for controlling processor(s) that, when executed, configures the processor to implement the following operations by the disclosed modules.

The unified communication interface 104 may involve a centralized interface that serves as a unified hub for SMS, email, and phone communication. A user 102 may interact with the system via the unified communication interface 104. The unified communication interface 104 may ensure a seamless and consistent experience for property managers and residents across different communication channels.

The contextual handover logic component 108 of the system may incorporate intelligent logic to determine the optimal channel for communication based on resident preferences and responsiveness. Contextual handover logic may ensure that messages are delivered through the most effective channel for each resident, maximizing engagement.

The communication history database 118 may be a dedicated database that stores communication histories, providing a comprehensive view of past interactions. The communication history database 118 may enable the system to maintain context across channels and facilitates personalized communication based on historical data

The real-time adaptability module 110 may dynamically switch communication channels based on resident behaviors and preferences. This may ensure that messages are delivered through the most responsive and preferred channels.

Integration with channel specific APIs 114 may allow the system to interact seamlessly with SMS gateways, email servers, and phone systems. The channel specific APIs 114 may ensure efficient and reliable communication across diverse channels.

The resident preference management system 106 may allow property managers to capture and update resident communication preferences. The resident preference management system 106 may ensure that messages are delivered through the channels preferred by each resident.

The feedback and analytics engine 116 may collect and analyze feedback from residents regarding communication preferences. The feedback and analytics engine 116 may provide valuable insights for continuous improvement and optimization of the communication strategy.

To enhance efficiency, the automated response generator 120 may generate predefined responses based on resident queries or actions. The automated response generator 120 may streamline communication and provide quick and accurate responses to common resident inquiries.

Ensuring the security and compliance of resident communication data may be critical (e.g., to resident trust). The security and compliance layer may implement encryption and access controls to safeguard sensitive communication information, ensuring compliance with data protection regulations.

The real-time synchronization module 112 may ensure that communication data is consistently updated across all channels. The real-time synchronization module 112 may guarantee property managers access to the latest resident communication information, regardless of the channel used.

The following examples illustrate how the Hybrid SMS, Email, and Phone Seamless Handover Communication System can be utilized to optimize resident communication within the real estate rental domain: 1 Streamlining Rent Payment Reminders; 2 Personalized Maintenance Requests; 3 Resident Engagement for Events; 4 Adapting to Urgency; 5 Tailored Lease Renewal Communication.
1. Streamlining Rent Payment Reminders: A resident habitually misses email rent payment reminders. The system analyzes this behavior and prioritizes SMS notifications for future due date reminders, ensuring the residents receive timely alerts through their preferred channel.
2. Personalized Maintenance Requests: A resident with limited English proficiency prefers phone communication for complex maintenance issues. The system identifies this preference and automatically connects them with a phone representative when they submit a maintenance request requiring detailed explanation.
3. Resident Engagement for Events: The property manager is hosting a resident appreciation event. The system leverages resident communication history to segment email invitations based on past preferences. Residents who previously responded positively to email event announcements will receive email invitations, while those who historically demonstrated a higher engagement rate with text message notifications will be notified via SMS.
4. Adapting to Urgency: A water leak occurs in a resident's apartment. The resident typically responds promptly to text messages but rarely checks their email. The system, upon receiving a maintenance request from this resident, prioritizes an SMS notification due to the urgency of the situation.
5. Tailored Lease Renewal Communication: A resident consistently engages with lease renewal information via email and expresses a preference for detailed communication. The system automatically sends a comprehensive lease renewal offer via email, outlining key terms and conditions. Additionally, the system can prompt the property manager to schedule a follow-up phone call to address any specific questions the resident may have.

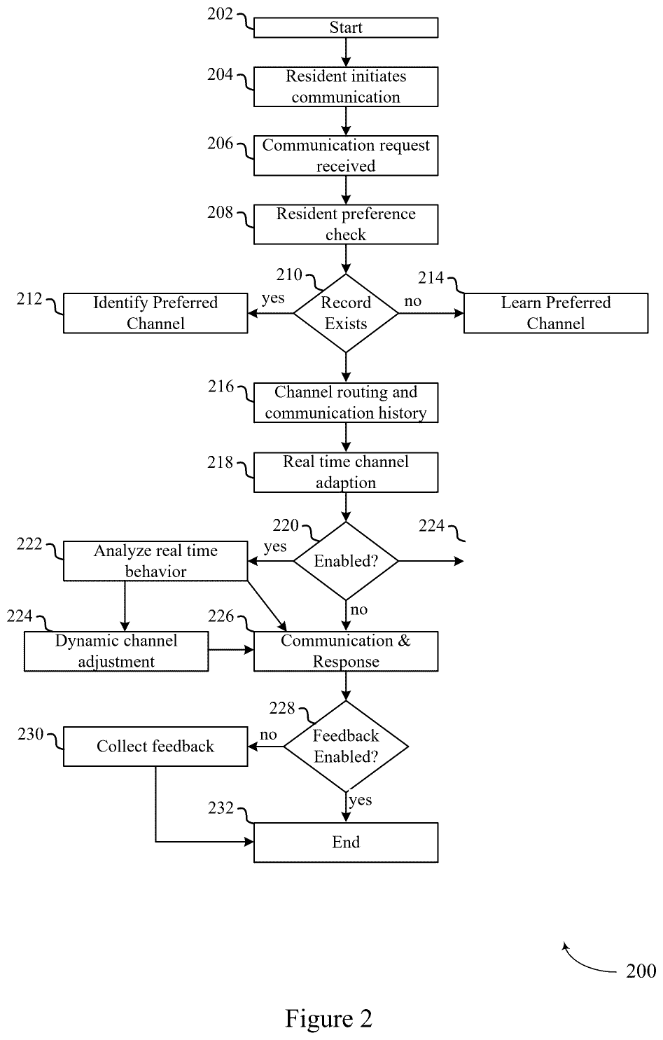

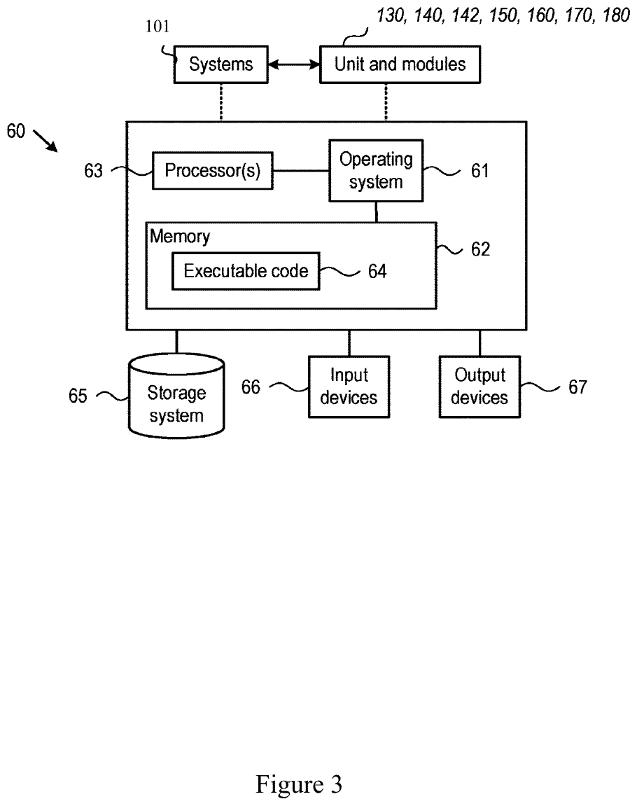

FIG. 2 shows an example of a flow chart of a method 200 that may be implemented by the system (e.g., the system architecture 100 of FIG. 1). The method 200 may be implemented by aspects of the system architecture 100 of FIG. 1 or by the controllers 60 of FIG. 3.

At 202, the method may start. At 204, the resident may initiate communication (e.g., via SMS text message, Email, or a phone call). At 206, the communication request may be received. For example, the unified communication interface 104 may capture the request at 206 and resident data (if available).

At 208, the system may perform a resident preference check. For example, if at 210, the system has a record of the resident's preferred communication channel (e.g., the resident who initiated the request at 204), the method may proceed to 212. If at 210, the system does not have a record of the resident's preferred communication channel. the method may proceed to 214.

At 212, the system may identify the resident's preferred channel. For example, the system may utilize the resident communication preference module (e.g., the resident preference management system 106) to identify the resident's preferred channel (e.g., SMS, email, phone).

At 214, the system may analyze past communication history with the resident (if available) to infer the preferred channel.

At 216, the system may route the communication request to the designated channel (SMS, Email, or Phone) based on the preference determined at 212 or the channel determined at 214. The system may store the communication request and any response within the resident communication history module (e.g., the communication history database 118).

In some examples, at 218, the system may perform real-time channel adaptation. For example, if a real-time adaptability module 110 is enabled for the system at 220, then the method may proceed to 222. If a real-time adaptability module 110 is not enabled for the system at 220, then the method may proceed to 226.

At 222, the system may analyze real-time behavior (if a real-time adaptability module 110 is enabled). For example, the real-time adaptability module 110 (also referred to as a real-time channel adaptability module) may determine whether the real-time resident behavior or preferences suggest a different channel may be more effective. If the real-time resident behavior or preferences suggest a different channel may be more effective at 222, then the system may dynamically adjust the communication channel for the interaction with the resident at 224 based on real-time insights. If the \ real-time resident behavior or preferences suggest a different channel may not be more effective at 222, the method may proceed to 226.

At 226, the system may deliver the communication through the designated channel (SMS, Email, or Phone call with a representative). The system may capture and store any resident responses within the communication history (e.g., within the communication history database 118)).

At 228, the system may determine whether there is a feedback and analytics engine 116 enabled for the system. If there is a feedback and analytics engine 116 enabled for the system, the method may proceed to 230. If there is not a feedback and analytics engine 116 enabled for the system, the method may proceed to end at 232.

At 230, the feedback and analytics engine 116 may collect resident feedback regarding communication preferences. The feedback and analytics engine 116 may analyze resident feedback to refine communication strategies and optimize resident engagement.

Thus, the integration of the Hybrid SMS, Email, and Phone Seamless Handover Communication System into Colleen.ai's rent collection automation platform represents a significant advancement in resident communication. By offering a unified and adaptable communication experience, property owners and managers may optimize engagement, improve responsiveness, and enhance the overall efficiency of the rent collection process.

FIG. 3 is a high-level block diagram of exemplary controllers 60, which may be used with embodiments of the present invention. Any of the systems (e.g., the system architecture 100, the system described herein), units or modules thereof (130, 140, 142, 150, 160, 170, 180) as well as any of stages of the method 200 may be implemented using controllers 60 or parts thereof such as processor(s). Controller(s) 60 may include one or more controller or processor 63 that may be or include, for example, one or more central processing unit processor(s) (CPU), one or more Graphics Processing Unit(s) (GPU or general-purpose GPU-GPGPU), a field-programmable gate array (FPGA), an application-specific integrated circuit (ASIC), a digital signal processor (DSP), a microprocessor, a chip, a microchip, an integrated circuit (IC), or any other suitable multi-purpose or specific processor, controller or computational device, an operating system 61, a memory 62, a storage 65, input devices 66 and output devices 67.

Operating system 61 may be or may include any code segment designed and/or configured to perform tasks involving coordination, scheduling, arbitration, supervising, controlling, or otherwise managing operation of controller(s) 60, for example, scheduling execution of programs. Memory 62 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long-term memory unit, or other suitable memory units or storage units. Memory 62 may be or may include a plurality of possibly different memory units. Memory 62 may store for example, instructions to carry out a method (e.g., code 64), and/or data such as user responses, interruptions, etc.

Executable code 64 may be any executable code, e.g., an application, a program, a process, task or script. Executable code 64 may be executed by controller 63 possibly under control of operating system 61. For example, executable code 64 may when executed cause the production or compilation of computer code, or application execution such as VR execution or inference, according to embodiments of the present invention. Executable code 64 may be code produced by methods described herein. For the various modules and functions described herein, one or more computing devices and/or components of controller(s) 60 may be used. Devices that include components similar or different to those included in controller(s) 60 may be used and may be connected to a network and used as a system. One or more processor(s) 63 may be configured to carry out embodiments of the present invention by, for example, executing software or code.

Storage 65 may be or may include, for example, a hard disk drive, a floppy disk drive, a Compact Disk (CD) drive, a CD-Recordable (CD-R) dlive, a universal serial bus (USB) device or other suitable removable and/or fixed storage unit. Data such as instructions, code, VR model data, parameters, etc. may be stored in a storage 65 and may be loaded from storage 65 into a memory 62 where it may be processed by controller 63. In some embodiments, some of the components shown in FIG. 4 may be omitted.

Input devices 66 may be or may include for example a mouse, a keyboard, a touch screen or pad or any suitable input device. It will be recognized that any suitable number of input devices may be operatively connected to controller(s) 60 as shown by block 66. Output devices 67 may include one or more displays, speakers and/or any other suitable output devices. It will be recognized that any suitable number of output devices may be operatively connected to controller(s) 60 as shown by block 67. Any applicable input/output (I/O) devices may be connected to controller(s) 60, for example, a wired or wireless network interface card (NIC), a modem, printer or facsimile machine, a universal serial bus (USB) device or external hard drive may be included in input devices 66 and/or output devices 67.

Embodiments of the disclosure may include one or more article(s) (e.g., memory 62 or storage 65) such as a computer or processor non-transitory readable medium, or a computer or processor non-transitory storage medium, such as for example a memory as disclosed herein, a disk drive, or a USB flash memory, encoding, including or storing instructions, e.g., computer-executable instructions, which, when executed by a processor or controller, carry out methods disclosed herein.

Unless specifically stated otherwise, as apparent from the following discussions, it is appreciated that throughout the specification discussions utilizing terms such as “processing”, “computing”, “calculating”, “determining”, “enhancing”, “deriving” or the like, ref er to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Elements from FIGS. 1 and 2 may be combined in any operable combination, and the illustration of certain elements in certain figures and not in others merely serves an explanatory purpose and is non-limiting.

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram or portions thereof.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram or pol lions thereof.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram or portions thereof.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A system for facilitating seamless communication handoff between Short Message Service (SMS), email, and phone channels, comprising:
a unified communication interface configured to:
receive communication requests from a resident;
identify a preferred communication channel based on resident preferences and communication history;
route the communication requests to a designated communication channel based on the preferred communication channel; and
store communication history across all channels for the resident;
a resident communication preference module configured to store and manage resident preferences for receiving communication from a property manager; and
at least one communication channel module configured to:
send communication to the resident through the designated communication channel (SMS, email, or phone); and
receive communication responses from the resident through the designated communication channel.

2. The system of claim 1, wherein the resident communication preference module is further configured to learn and update resident preferences based on resident interaction patterns across communication channels.

3. The system of claim 1, wherein the unified communication interface prioritizes routing communication requests based on urgency and a nature of the communication requests.

4. The system of claim 3, wherein the system prioritizes routing urgent communication requests, such as maintenance emergencies, through phone calls.

5. The system of claim 1, wherein the at least one communication channel module further comprises an SMS communication module configured to send and receive text messages with residents.

6. The system of claim 1, wherein the at least one communication channel module further comprises an email communication module configured to send and receive emails with residents.

7. The system of claim 1, wherein the at least one communication channel module further comprises a phone communication module configured to connect residents with property management representatives via phone calls.

8. The system of claim 1, further comprising a resident communication history module configured to store and manage all communication interactions between a resident and property management across all communication channels (SMS, email, and phone).

9. The system of claim 1, further comprising a contextual handover logic engine configured to analyze the communication history and resident preferences to determine a most effective communication channel for future outreach.

10. The system of claim 1, further comprising a real-time channel adaptability module configured to dynamically adjust the designated communication channel based on real-time resident behavior and preferences.

11. The system of claim 1, further comprising a feedback and analytics engine configured to:
collect resident feedback regarding communication preferences; and
analyze the resident feedback to refine communication strategies and optimize resident engagement.

12. The system of claim 1, further comprising an automated response generator configured to generate predefined responses to common resident inquiries.

13. The system of claim 1, wherein the unified communication interface and the at least one communication channel module comply with relevant data security protocols and utilize encryption techniques to safeguard resident communication data.

14. A method for facilitating seamless communication handoff between Short Message Service (SMS), email, and phone channels for resident communication within a real estate rental domain, the method comprising:
receiving a communication request from a resident;
identifying a preferred communication channel for the resident based on resident preferences and communication history;
routing the communication request to a designated communication channel (SMS, email, or phone) based on the preferred communication channel;
storing the communication request and any responses within a resident communication history; and
learning and updating resident communication preferences based on resident interaction patterns across communication channels.

15. The method of claim 14, wherein identifying a preferred communication channel prioritizes routing communication requests based on urgency and a nature of the communication request.

16. The method of claim 15, further comprising prioritizing routing urgent communication requests through phone calls.

17. The method of claim 14, further comprising analyzing the communication history and resident preferences to determine a most effective communication channel for future outreach.

18. The method of claim 14, further comprising dynamically adjusting the designated communication channel based on real-time resident behavior and preferences.

19. The method of claim 14, further comprising:
collecting resident feedback regarding communication preferences; and
analyzing the resident feedback to refine communication strategies and optimize resident engagement.

20. The method of claim 14, further comprising generating predefined responses to common resident inquiries.

21. The method of claim 14, further comprising complying with relevant data security protocols and utilizing encryption techniques to safeguard resident communication data.
